(19) United States
(12) Patent Application Publication
(10) Pub. No.: US 2011/0018949 A1
(43) Pub. Date: Jan. 27, 2011

(54) IMAGE POSITION DETECTING DEVICE AND IMAGE FORMING APPARATUS USING THE SAME

(75) Inventor: Kenta OGATA, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/840,631

(22) Filed: Jul. 21, 2010

(30) Foreign Application Priority Data
Jul. 22, 2009 (JP) 2009-171377

(51) Int. Cl. G03G 15/01; G01B 11/14; G01J 3/00

(52) U.S. Cl. 347/119; 356/51; 356/620

(57) ABSTRACT

An image position detecting device includes a light irradiating unit and a photodetector. The light irradiating unit is disposed so as to face a movable body which is being moved in a certain direction. The light irradiating unit irradiates any of marks formed on the movable body with light having a wavelength in an ultraviolet range at a time. The marks are formed of color components, respectively. The photodetector is provided separately from the light irradiating unit to face the movable body. The photodetector detects light having a wavelength in the ultraviolet range from light regularly reflected by the irradiated mark.

### CROSS-REFERENCE TO RELATED APPLICATIONS

This application is based on and claims priority under 35 USC 119 from Japanese Patent Application No. 2009-171377 filed Jul. 22, 2009.

### BACKGROUND

### Technical Field

The present invention relates to an image position detecting device and an image forming apparatus using the image position detecting device.

### SUMMARY

According to one aspect of the invention, an image position detecting device includes a light irradiating unit and a photodetector. The light irradiating unit is disposed so as to face a movable body which is being moved in a certain direction, the light irradiating unit that irradiates any of marks formed on the movable body with light having a wavelength in an ultraviolet range at a time. The marks are formed of color components, respectively. The photodetector is provided separately from the light irradiating unit to face the movable body. The photodetector detects the light having the wavelength in the ultraviolet range from light regularly reflected by the irradiated mark.

### BRIEF DESCRIPTION OF THE DRAWINGS

Exemplary embodiments of the invention will be described in detail below based on the accompanying drawings, wherein:

FIG. 1A is an explanatory view showing an outline of an image forming apparatus according to an exemplary embodiment of the invention;

FIG. 1B is an explanatory view showing an outline of an image position detecting device, shown in FIG. 1A, according to the exemplary embodiment of the invention;

FIG. 2 is an explanatory view showing the entire structure of an image forming apparatus according to a first exemplary embodiment;

FIG. 3A is an explanatory view showing an example of generating color shift detecting patterns;

FIG. 3B is an explanatory view showing an example of the color shift detecting pattern;

FIG. 4 is an explanatory view showing a color shift sensor (an example of the image position detecting device) which is used in the exemplary embodiment;

FIG. 5A is an explanatory view showing an example of a light receiving portion of a photodetector;

FIG. 5B is an explanatory view showing a color shift detecting principle of the color shift sensor;

FIG. 6A is an explanatory chart showing an example of an output of the photodetector which is used in the exemplary embodiment;

FIG. 6B is an explanatory chart showing an example of an output of the photodetector which is different from that of the exemplary embodiment;

FIG. 7 is a flowchart showing a color shift control process according to the exemplary embodiment;

FIGS. 8A to 8D are explanatory charts showing output characteristics of the color shift sensor which is used in the exemplary embodiment, that is, showing reflectance characteristics for color shift detecting patterns of respective color components when the color shift detecting patterns are irradiated with light having a wavelength in an ultraviolet range;

FIGS. 9A to 9D are explanatory charts showing output characteristics of a color shift sensor which is used in a comparative example, that is, showing reflectance characteristics for the color shift detecting patterns of the color components when the color detecting patterns are irradiated with the light having the wavelength in the infrared region;

FIG. 10 is an explanatory view showing a color shift sensor (an example of the image position detecting device) which is used in a second exemplary embodiment;

FIG. 11A is an explanatory view showing an appearance of a color shift sensor (an example of the image position detecting device) which is used in a third exemplary embodiment;

FIG. 11B is a section view of the color shift sensor as seen from a direction B shown in FIG. 11A;

FIG. 12 is an explanatory view showing a color shift sensor (an example of the image position detecting device) which is used in a fourth exemplary embodiment;

FIG. 13A is an explanatory view showing points P₁ to P₃ of a color shift detecting pattern which is used in the fourth exemplary embodiment;

FIG. 13B is an explanatory view showing a relative positional relationship between the points P₁ to P₃ shown in FIG. 13A and light receiving portions of a photodetector;

FIG. 14A is an explanatory view showing an optical path along which light reflected by P₁ reaches the light receiving portions of the photodetector;

FIG. 14B is an explanatory view showing an optical path along which light reflected by P₂ reaches the light receiving portions of the photodetector;

FIG. 14C is an explanatory view showing an optical path along which light reflected by P₃ reaches the light receiving portions of the photodetector;

FIG. 15A is an explanatory chart showing a relationship between a focal length of a color shift sensor and color registration (color shift) according to Example 1;

FIG. 15B is an explanatory chart showing a relationship between a focal length of a color shift sensor and color registration (color shift) according to Comparative Example 1;

FIG. 16 is an explanatory chart showing a relationship between a process speed and an output of a color shift sensor in an image forming apparatus according to Example 2; and

FIG. 17 is an explanatory chart showing a relationship between a detecting area of a color shift sensor and a minimum pattern width of a color shift detecting pattern according to Example 3.

### DETAILED DESCRIPTION

### Outline of Exemplary Embodiment

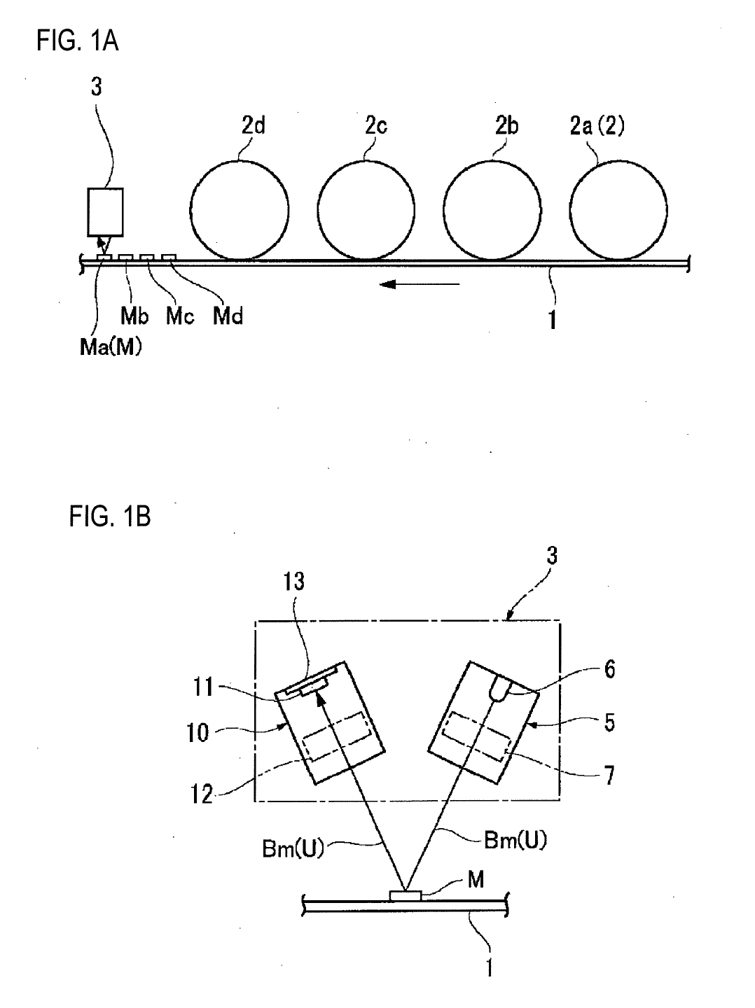

FIG. 1A shows an outline of an image forming apparatus according to an exemplary embodiment of the invention.

In FIG. 1A, the image forming apparatus includes a movable body 1, image forming sections 2 (for example, 2a to 2d) and an image position detecting device 3. The movable body 1 is configured to be moved in a predetermined direction. The image forming sections 2 form, on the movable body 1, marks M (for example, Ma to Md) which are formed of respective color components. The image position detecting device 3 detects the marks M.

As shown in FIG. 1B, the image position detecting device 3 includes a light irradiating unit 5 and a photodetector 10. The light irradiating unit 5 is disposed so as to face the movable body 1. The light irradiating unit 5 irradiates any of the marks M (Ma to Md) with light Bm(U) having a wavelength in an ultraviolet range at a time. The photodetector 10 is provided separately from the light irradiating unit 5 to face the movable body 1. The photodetector 10 detects the light Bm(U) having the wavelength in the ultraviolet range from light regularly reflected by the irradiated mark M (Ma to Md).

In FIGS. 1A and 1B, the movable body 1 travels from the right side to the left side as indicated by an arrow shown in FIG. 1A. When viewed from above the image position detecting device 3, the light irradiating unit 5 and the photodetector 10 are arranged along a travel direction of the movable body 1. Alternatively, when viewed from above the image position detecting device 3, the light irradiating unit 5 and the photodetector 10 may be arranged along a direction intersecting the travel direction of the movable body 1, particularly, a direction substantially perpendicular to the travel direction of the movable body 1.

The movable body 1 may have any configuration so long as the marks M (Ma to Md) are formed thereon. Examples of the movable body 1 include an image carrier that directly carries the images of the color components, a recording-material transporting body that transports a recording material on which an image is to be recorded, and the recording material itself.

Examples of the image position detecting mark M include a patch and a pattern which are used to detect a position of an image.

Also, the image forming sections 2 may be provided separately for the respective color components as shown in FIG. 1A. Alternatively, one image forming section 2 may be shared by plural color components. Further alternatively, one image forming section 2 may be shared by the all color components (for example, a four-cycle type).

Also, the single image position detecting device 3 may be provided for the movable body 1. Alternatively, plural image position detecting devices 3 may be provided, and an averaging process may be performed therefore.

Moreover, the light irradiating unit 5 may have any configuration so long as it has a light emitting portion 6 that emits at least the light Bm(U) having the wavelength in the ultraviolet range. Also, the light irradiating unit 5 may include various optical elements in addition to the light emitting portion 6.

Furthermore, the photodetector 10 may have any configuration so long as it has a light receiving portion 11 that receives at least the light Bm(U) having the wavelength in the ultraviolet range. The photodetector 10 may include various optical elements in addition to the light receiving portion 11.

In the exemplary embodiment, typical modes of the light irradiating unit 5 and the photodetector 10 include (i) the case where the light irradiating unit 5 irradiates the mark M only with the light Bm(U) having the wavelength in the ultraviolet range and (ii) the case where the light with which the light irradiating unit 5 irradiates the mark M has the wavelength in the ultraviolet range and a wavelength in a range other than the ultraviolet range and the photodetector 10 includes a light eliminating member (not shown) that eliminates the light having the wavelength in the range other than the ultraviolet range.

The light irradiating unit 5 may include an emission portion 6 and an optical guiding member 7. The emission portion 6 emits the light having the wavelength in the ultraviolet range. The optical guiding member 7, such as a collimator lens, guides the light from the light emitting portion 6 toward the mark M in a state where the light emitted from the emission portion 6 is in a parallel light beam.

The photodetector 10 may include a pair of light receiving portions 11. The light receiving portions 11 may be symmetrically arranged with respect to a reference center line. In this example, each light receiving portion 11 may have a single light receiving cell or may have a light receiving cell divided into plural parts.

The photodetector 10 having the light receiving portions 11 may include an optical imaging member 12 in an optical path of the light regularly reflected by the irradiated mark M. The optical imaging member 12 focuses the light regularly reflected by the irradiated mark M into an image on the pair of the light receiving portions 11. The optical imaging member 12 may be inclined with respect to an axis of the optical path so as to decrease a difference between (i) an optical path length between one of the light receiving portions 11 and the irradiated mark M and (ii) an optical path length between the other light receiving portion 11 and the irradiated mark M. This example is a mechanism for decreasing the difference in length between optical paths reaching the light receiving portions 11 by devising a layout of the optical imaging member 12.

Alternatively, the photodetector 10 having the light receiving portions 11 may include a substrate 13 on which the light receiving portions 11 are mounted. The substrate 13 is inclined with respect to the axis of the optical path so as to decrease the difference between (i) the optical path length between the one of the light receiving portions 11 and the irradiated mark M and (ii) the optical path length between the other light receiving portion 11 and the irradiated mark M. This example is a mechanism for decreasing the difference in length between the optical paths reaching the light receiving portions 11 by devising a layout of the substrate 13 on which the light receiving portions 11 are mounted.

Further alternatively, the light irradiating unit 5 and the photodetector 10 having the light receiving portions 11 may be disposed so that the light irradiating unit 5 is located in a direction extending along the centerline of the light receiving portions 11 of the photodetector 10. This example is a mechanism for decreasing the difference in length between the optical paths reaching the light receiving portions 11 by devising layouts of the photodetector 10 and the light irradiating unit 5.

Exemplary embodiments of the invention will be described below in more detail with reference to the accompanying drawings.

### First Exemplary Embodiment

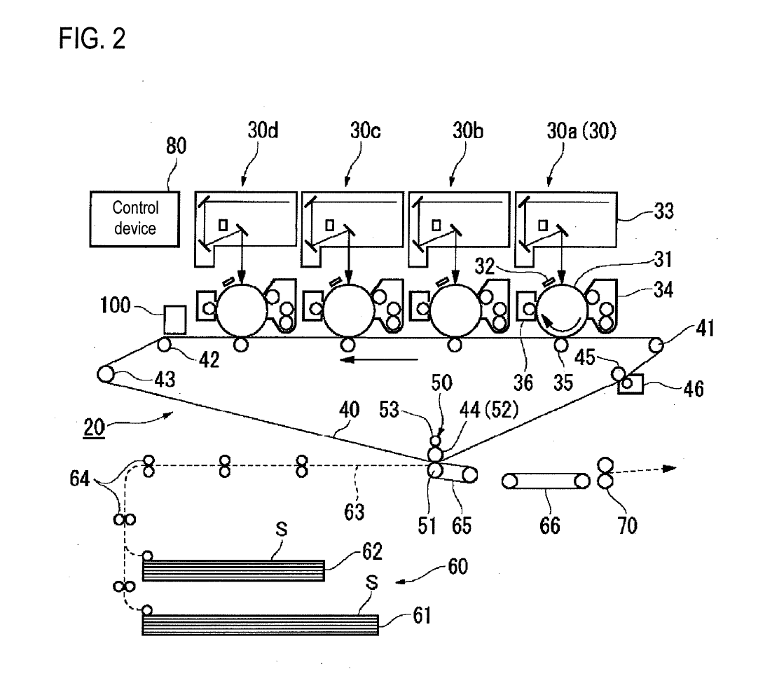

FIG. 2 is an explanatory view showing the entire structure of an image forming apparatus according to a first exemplary embodiment.

In FIG. 2, an image forming apparatus 20 has plural image forming sections 30 (30a to 30d), an intermediate transfer belt 40, a secondary transfer unit 50 and a recording-material transport system 60. Images of color components of yellow (Y), magenta (M), cyan (C) and black (K) are formed on the image forming sections 30 (30a to 30d), for example. The image forming apparatus 20 circulates and moves the intermediate transfer belt 40 in a part where the intermediate transfer belt 40 faces the image forming sections 30, and sequentially transfers the images of the color components, which are formed by the image forming sections 30, onto the intermediate transfer belt 40. Furthermore, the image forming apparatus 20 secondarily transfers, by means of the secondary transfer unit 50, a multi-transfer image on the intermediate transfer belt 40 to a recording material S which is transported by the recording-material transport system 60.

Each image forming section 30 has a drum-shaped photosensitive body 31, and also has a charger 32, an exposing unit 33, a developing unit 34, a transfer unit 35 and a cleaning unit around the photosensitive body 31. The photosensitive body 31 is rotated in a certain direction. The charger 32, such as a corotron, charges the photosensitive body 31. The exposing unit 33, such as a laser scanning device, writes an electrostatic latent image to the charged photosensitive body 31. The developing unit 34 changes the electrostatic latent image on the photosensitive body 31 into a visible image with a toner of a color component corresponding to each image forming section 30. The transfer unit 35, such as a transfer roll, primarily transfers a developed image (a toner image) on the photosensitive body 31 to the intermediate transfer belt 40. The cleaning unit 36 cleans away a residual toner on the photosensitive body 31.

The intermediate transfer belt 40, for example, includes a polyimide resin. The intermediate transfer belt 40 is laid over plural tension rolls 41 to 45 and is circulated and moved with the tension roll 41 being used as a driving roll, for instance.

In the example, the tension roll 42 is disposed on a virtual line extending from a straight part of the intermediate transfer belt 40 which faces the respective image forming sections 30 (30a to 30d). The tension roll 43 serves as a tension applying roll for applying a tension to the intermediate transfer belt 40. The tension roll 44 serves as a roll 52 which is opposite to a secondary transfer roll 51 which is the secondary transfer unit 50. Also, a belt cleaner 46 for cleaning away a toner remaining on the intermediate transfer belt 40 is provided in a part opposite to the tension roll 45. Reference numeral 53 denotes a supply roller for supplying, to the opposite roll 52, a transfer voltage required for secondary transfer.

Furthermore, the recording-material transport system 60 has recording material feeding devices 61 and 62 that feeding the recording material S. A certain transporting path 63 is provided so that the recording material S fed from the recording material feeding devices 61 and 62 passes through a secondary transfer part. Also, the transporting path 63 is provided with a proper number of transport rolls 64 and transport belts 65 and 66. The recording materials S fed from the recording material feeding devices 61 and 62 are transported to the secondary transfer part and are then transported to a fixing unit 70 via the transport belts 65 and 66, and a secondarily-transferred image is fixed onto the recording materials S by the fixing unit 70.

In the exemplary embodiment, moreover, a color shift sensor 100 (an example of an image position detecting device) is disposed on a downstream side of the straight part of the intermediate transfer belt 40, which is in the most-downstream image forming section 30d, in a moving direction of the intermediate transfer belt 40 with facing and being in non-contact with a surface the intermediate transfer belt 40.

In FIG. 2, reference numeral 80 denotes a control device that controls respective devices/units of the image forming sections 30 (30a to 30d), the intermediate transfer belt 40, the recording-material transport system 60 and the fixing unit 70 to execute an image forming process and to perform a color shift control process by the respective image forming sections 30.

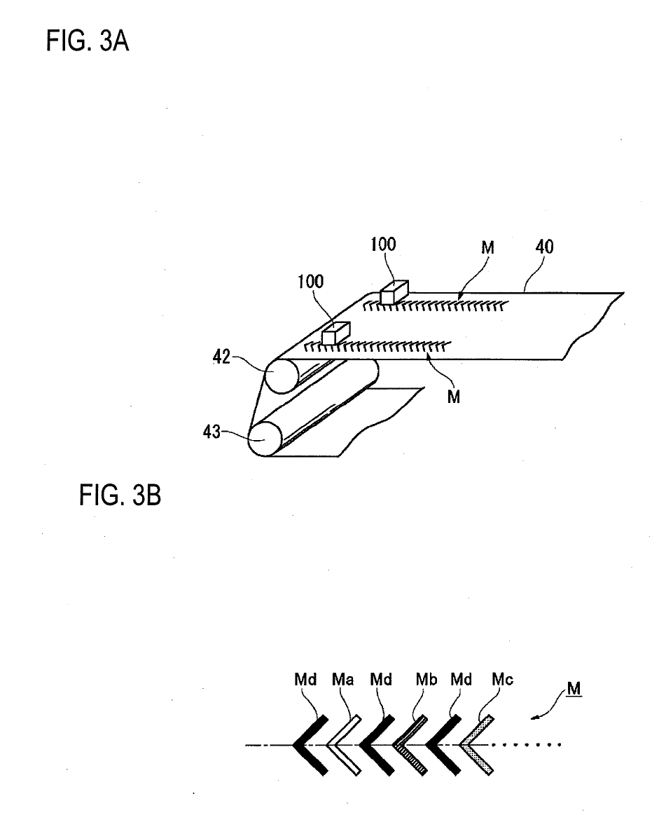

In the exemplary embodiment, a pair of color shift sensors 100 is provided opposite to each other on both sides in a width direction crossing the moving direction of the intermediate transfer belt 40 as shown in FIG. 3A, for example. The pair of color shift sensors 100 detect color shift detecting patterns M shown in FIGS. 3A and 3B.

In the example, the color shift detecting patterns M (specifically, Ma to Md) are formed at predetermined timings by using the image forming sections 30 (30a to 30d). For example, each color shifter detecting pattern M is a V-shaped pattern, which protrudes in the moving direction of the intermediate transfer belt 40, is bent at an angle of 90 degrees, and is formed with a corresponding color toner. Particularly, the example is configured so that color shifts in the color shift detecting patterns Ma to Mc for Y, M and C colors are detected based on the color shift detecting pattern Md for K color.

### —Color Shift Sensor (Example of Image Position Detecting Device)—

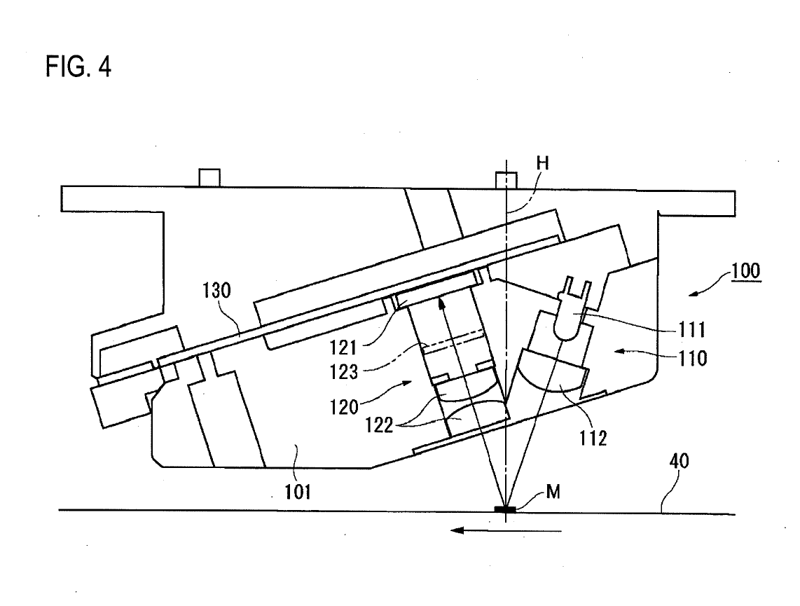

In the exemplary embodiment, the color shift sensor 100 (one example of the image position detecting device) includes a light irradiating unit 110 and a photodetector 120 in a sensor container 101 as shown in FIG. 4. The light irradiating unit 110 irradiates the color shift detecting pattern M (Ma to Md) on the intermediate transfer belt 40 with light. The photodetector 120, which is provided separately from the light irradiating unit 110, detects light regularly reflected by the color shift detecting pattern M (Ma to Md) on the intermediate transfer belt 40. The light irradiating unit 110 is disposed on an upstream side, in the moving direction of the intermediate transfer belt 40, with being opposite to the photodetector 120 across a vertical line H passing through a light irradiated part of the intermediate transfer belt 40. An arrow shown in FIG. 4 indicates a travel direction of the intermediate transfer belt 40. In the exemplary embodiment, when viewed from above the color shift sensor 100, the light irradiating unit 110 and the photodetector 120 are arranged along the travel direction of the intermediate transfer belt 40.

In the exemplary embodiment, the light irradiating unit 110 is disposed on the upstream side of the photodetector 120 in the moving direction of the intermediate transfer belt 40. The light irradiating unit 110 includes a light emitting portion 111 and an optical guiding lens 112. The light emitting portion 111, such as an LED, emits only light having a wavelength in an ultraviolet range. In the example, the optical guiding lens 112 changes the light emitted from the light emitting portion 111 into a parallel beam and irradiates the color shift detecting pattern M (Ma to Md) with the parallel beam.

Also, the photodetector 120 includes a light receiving portion 121 and an optical imaging lens 122. The light receiving portion 121 detects the light regularly reflected by the color shift detecting pattern M (Ma to Md). The optical imaging lens 122 is provided on a front side of the light receiving portion 121 and focuses the light regularly reflected by the color shift detecting pattern M (Ma to Md) to form an image on the light receiving portion 121. Reference numeral 130 denotes a substrate on which the photodetector 120 is mounted.

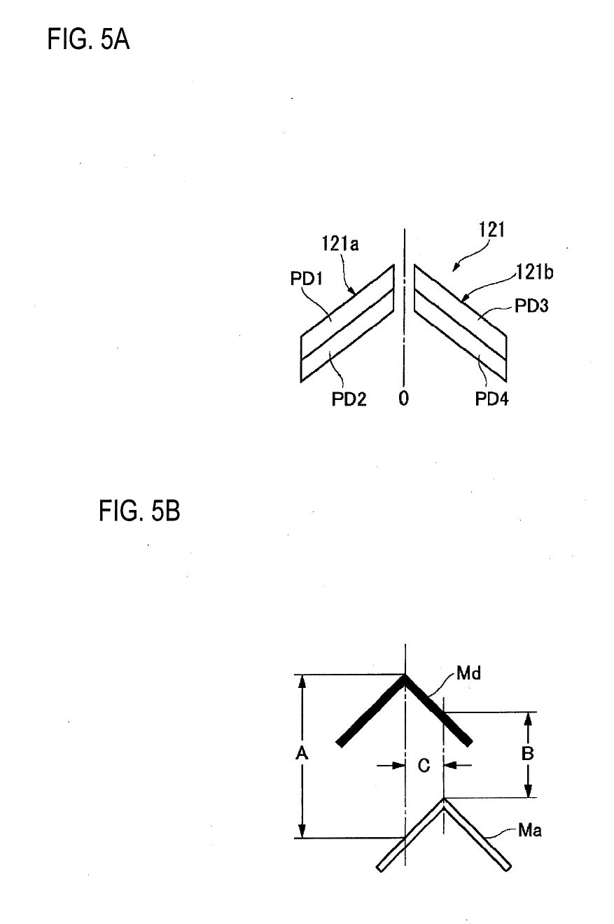

In the exemplary embodiment, as shown in FIG. 5A, the light receiving portions 121 of the photodetector 120 have such a pair structure that the light receiving portions 121 are separation from each other with being opposite to each other across a central axis O. The light receiving portions 121 (121a, 121b) having the pair structure are disposed so as to correspond to the color shift detecting pattern M (Ma to Md) of the V-shaped pattern. The light receiving portion 121a is divided into two light receiving cells PD1 and PD2, and the light receiving portion 121b is divided into two light receiving cells PD3 and PD4.

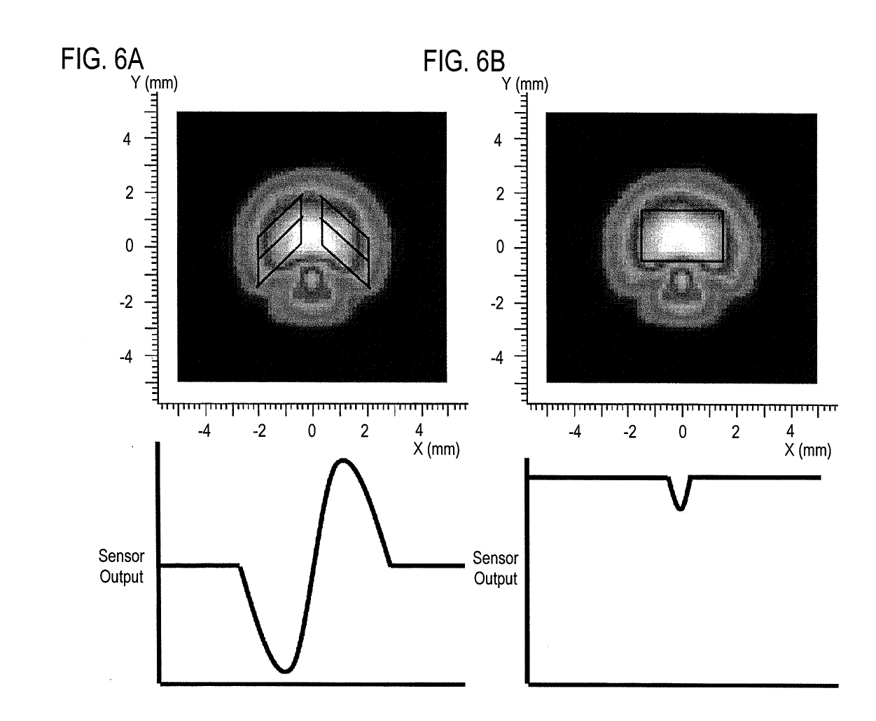

An output characteristic of the light receiving portion 121 of the photodetector 120 shows a sine waveform which has the central axis O as a boundary as shown in FIG. 6A, for example. Therefore, it is possible to grasp a position of a central part (corresponding to a tip part of the V shape) of the color shift detecting pattern M (Ma to Md) more accurately as compared with a comparative example shown in FIG. 6B (in which a light receiving portion of a photodetector is formed of a single light receiving cell), for example.

In the exemplary embodiment, therefore, even if the color shift detecting pattern Md for the K color and the color shift detecting pattern Ma for the Y color are shifted from each other in the width direction of the intermediate transfer belt 40, for example, it is possible to grasp a relative position of the color shift detecting pattern Ma for the Y color with respect to the color shift detecting pattern Md for the K color based on a distance A in the moving direction of the intermediate transfer belt 40 between a position of a central part of the color shift detecting pattern Md for the K color and the color shift detecting pattern Ma for the Y color as shown in FIG. 5B. In consideration of a difference between the distance A and a distance B, in the moving direction of the intermediate transfer belt 40, between a position of a central part of the color shift detecting pattern Ma for the Y color and the color shift detecting pattern Md for the K color, it is also possible to grasp a shift amount C of the color shift detecting pattern Ma for the Y color in the width direction.

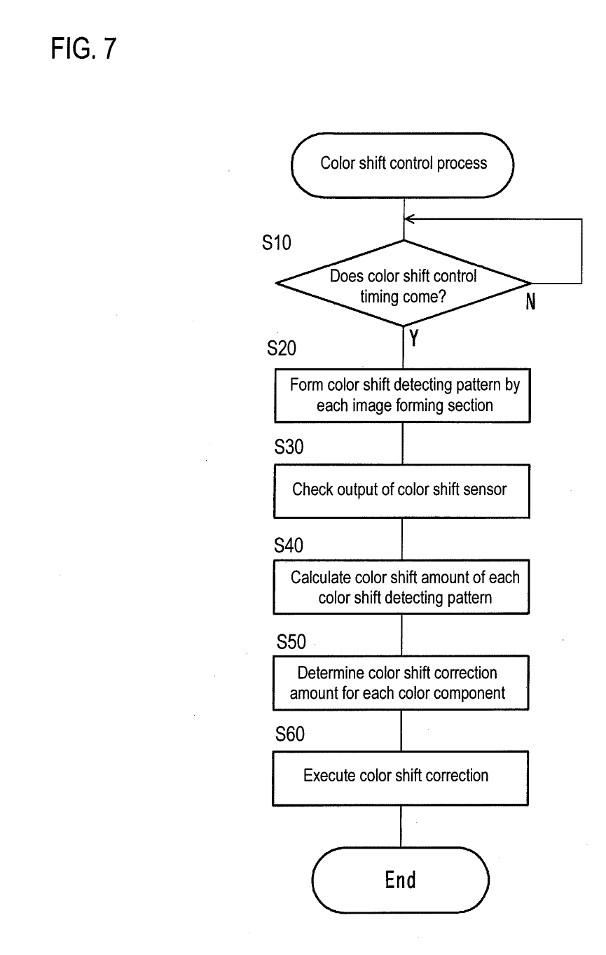

Next, a color shift control process according to the exemplary embodiment will be described with reference to FIG. 7.

First of all, the control device 80 determines as to whether or not a color shift control timing comes (step S10).

The color shift control timing may be selected appropriately. Examples of the color shift control timing include a timing at which a first job has been started since power is turned on and a timing whenever the certain number of sheets is printed.

If the control device 80 determines that the color shift control timing comes (Yes at step S10), the control device 80 controls each image forming section 30 (30a to 30d) to from the color shift detecting pattern M (Ma to Md) for the corresponding color (step S20).

Subsequently, the control device 80 checks an output of the color shift sensor 100 (step S30) and calculates a color shift amount of each color shift detecting pattern M (Ma to Md) (step S40). Then, the control device 80 determines a color shift correcting amount for each color component and executes color shift correction (for example, corrects a writing start position of an electrostatic latent image for each color component image) (step S50).

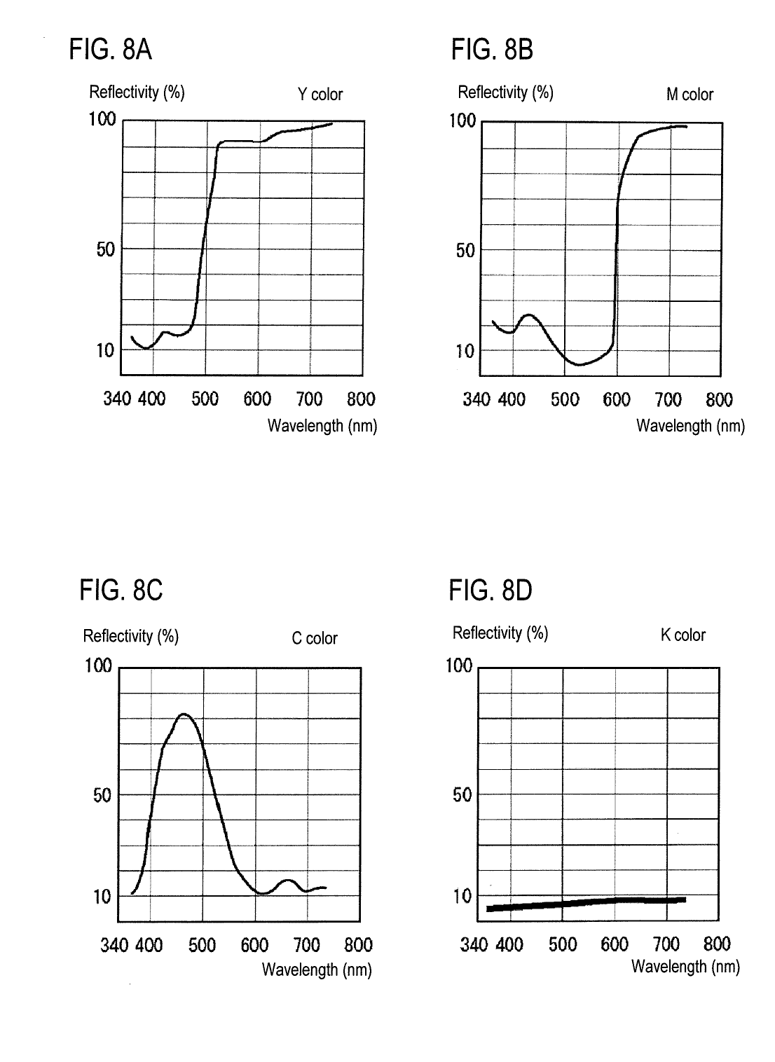

In the color shift control process, the color shift sensor 100 uses light having a wavelength (for example, 395 nm) in the ultraviolet range. Therefore, as show in FIGS. 8A to 8D, reflectivities of the color shift detecting patterns Ma to Md of the respective color components (Y, M, C and K) are approximately 10% and are almost equal to each other for. Therefore, it can be understood that a variation in sensor sensitivity is small.

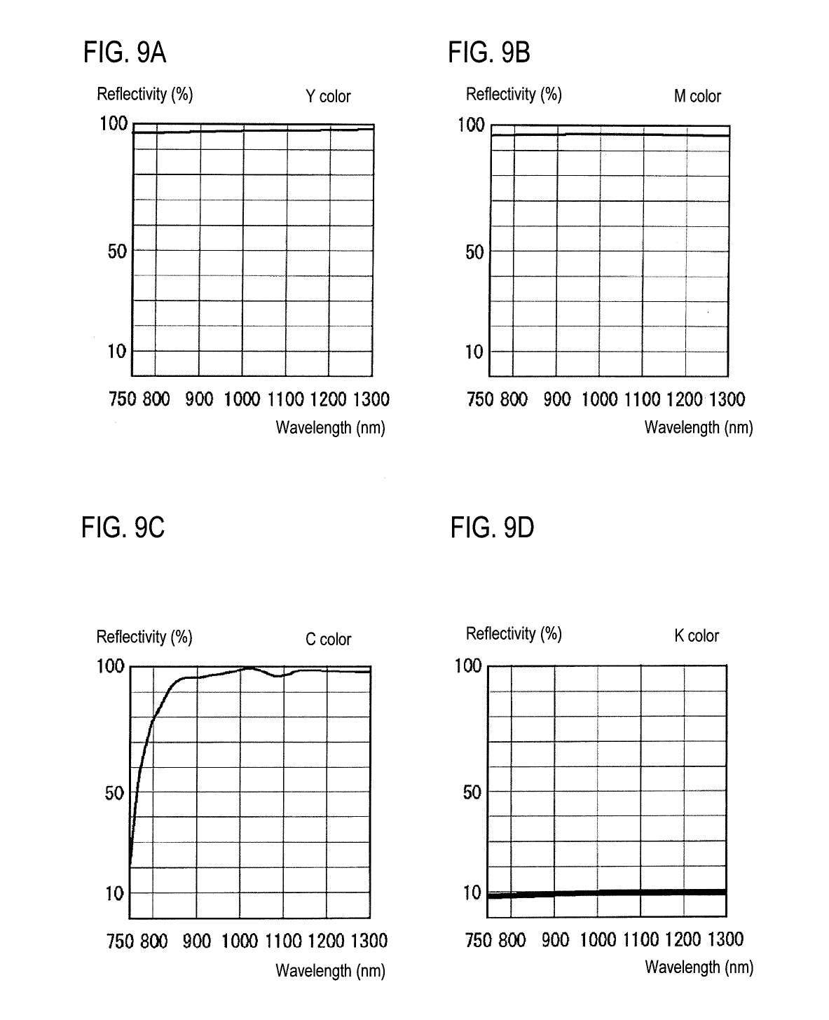

It is assumed that light having a wavelength (for example, 940 nm) in an infrared region is used for the color shift sensor (comparative example). In this case, reflectivities of the color shift detecting patterns Ma to Mc of the Y, M and C colors are higher than that for the K color as shown in FIGS. 9A to 9D. Therefore, it can be understood that the variation in sensor sensitivity is large.

In the exemplary embodiment, thus, the detection sensitivities of the color shift sensor 100 for the color shift detecting patterns M (Ma to Md) are almost equal. As compared with the comparative the comparative example where the sensor sensitivities for the respective color components have variation, therefore, the detection sensitivities of the color shift sensor 100 can be maintained with high accuracy.

### <First Modification>

In the first exemplary embodiment, the light emitting portion 111 of the light irradiating unit 110 in the color shift sensor 100 emits only the light having the wavelength in the ultraviolet range. However, the invention is not limited thereto. The light emitting portion 111 of the light irradiating unit 110 may emit light having a wavelength in a range other than the ultraviolet range as well as the light having the wavelength in the ultraviolet range. In this case, as shown in FIG. 4 by dashed-two dotted line, the photodetector 120 is provided with an optical filter 123 that eliminates the light having the wavelength in the range other than the ultraviolet range, for example.

### Second Exemplary Embodiment

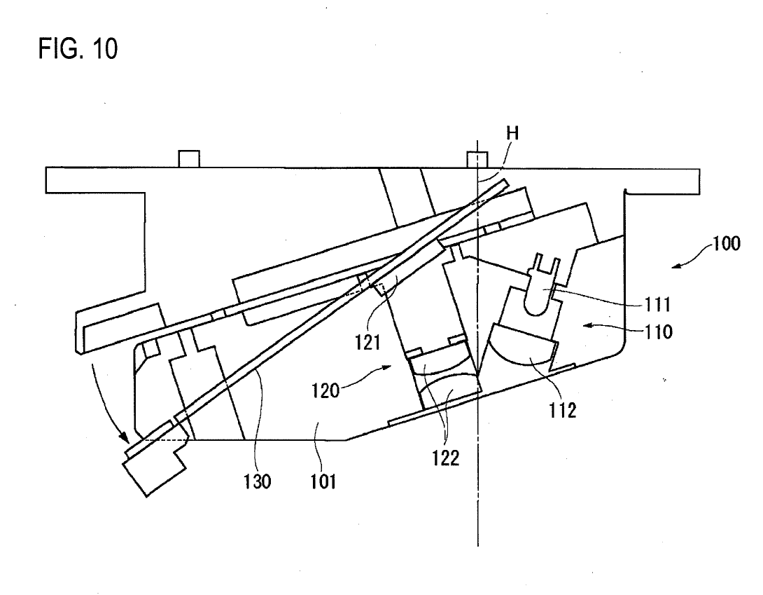

FIG. 10 shows a color shift sensor (one example of the image position detecting device) according to a second exemplary embodiment.

In FIG. 10, the basic configuration of the color shift sensor 100 (one example of the image position detecting device) is similar to that of the first exemplary embodiment and is different from that of the first exemplary embodiment in that a substrate 130 is inclined so as to decrease a difference between (i) an optical path length between one of the light receiving portions 121 and the irradiated color shift detecting mark M (Ma to Md) and (ii) an optical path length between the other light receiving portion 121 and the irradiated color shift detecting mark M (Ma to Md). Although not shown in FIG. 10, in the exemplary embodiment, it is assumed that the intermediate transfer belt travels from the right side to the left side as in FIG. 4.

In the second exemplary embodiment, it is possible to properly incline a light receiving surface of the light receiving portions 121 of the photodetector 120 having the pair structure by optimally setting a inclination posture of the substrate 130. Also, in the second exemplary embodiment, it is possible to suppress the difference between the optical path lengths to the light receiving portions 121 of the photodetector 120 having the pair structure. Therefore, the light regularly reflected by the color shift detecting pattern M forms an image in a small amount of out-of-focus from the light receiving portion 121. Thus, higher accuracy in detection sensitivities of the color shift sensor 100 can be achieved.

### Third Exemplary Embodiment

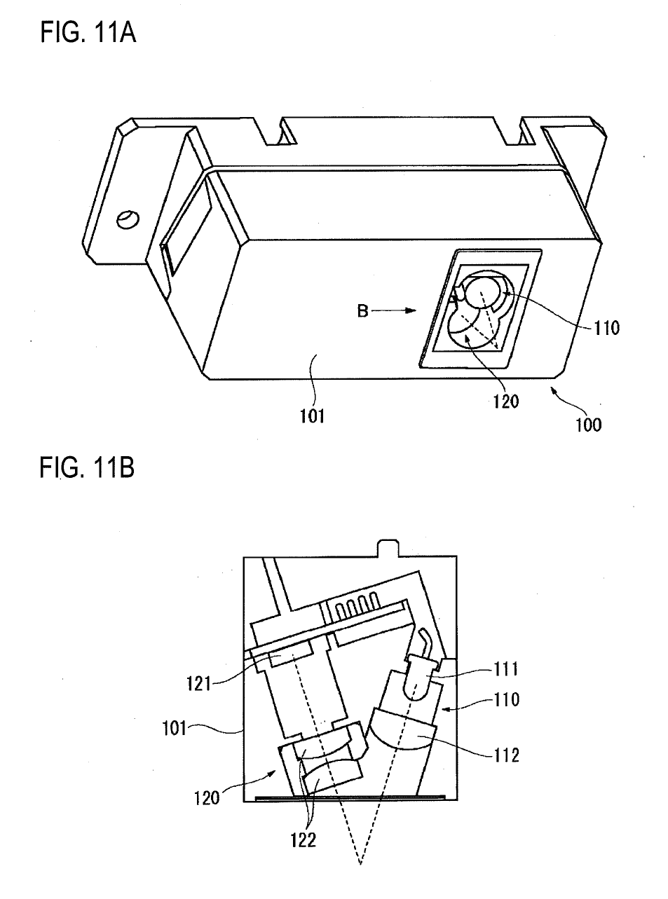

FIGS. 11A and 11B show a color shift sensor (one example of the image position detecting device) according to a third exemplary embodiment.

In FIGS. 11A and 11B, the basic configuration of a color shift sensor 100 (one example of the image position detecting device) is similar to that of the first exemplary embodiment and is different from that of the first exemplary embodiment in that a light irradiating unit 110 and a photodetector 120 are disposed so that the light irradiating unit 110 is located in a direction extending along a centerline of light receiving portions 121 of the photodetector 120 having a pair structure so as to decrease a difference between (i) an optical path length between one of the light receiving portions 121 and the irradiated color shift detecting mark M (Ma to Md) and (ii) an optical path length between the other light receiving portion 121 and the irradiated color shift detecting mark M (Ma to Md). Although not shown in FIG. 11B, in the exemplary embodiment, it is assumed that the intermediate transfer belt travels from the rear side of the paper of FIG. 11B to the front side thereof. When viewed from above the color shift sensor 100, the light irradiating unit 110 (particularly, light emitting portion 111) and the photodetector 120 (particularly, light receiving portions 121) are arranged along a direction substantially perpendicular to the travel direction of the intermediate transfer belt.

As compared with the first exemplary embodiment, a position where the color shift sensor 100 is provided is rotated by 90 degrees around a virtual line axis of the intermediate transfer belt 40 in a vertical direction. In the third exemplary embodiment, for example, it is possible to further suppress the difference between the optical path lengths to the light receiving portions 121 of the photodetector 120 having the pair structure as compared with the first exemplary embodiment. Therefore, the light regularly reflected by the color shift detecting pattern M forms an image in a small amount of out-of-focus from the light receiving portion 121. Thus, higher accuracy in detection sensitivities of the color shift sensor 100 can be achieved.

### Fourth Exemplary Embodiment

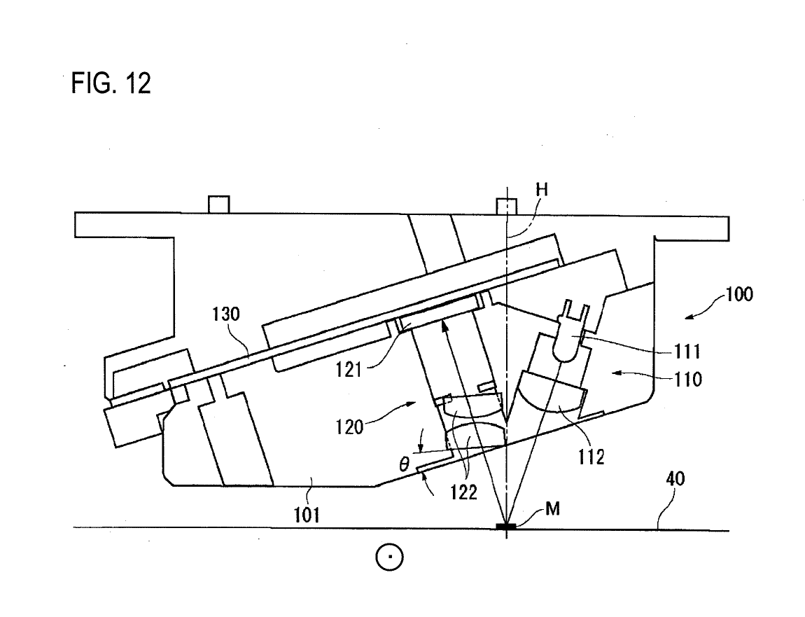

FIG. 12 shows a color shift sensor (one example of the image position detecting device) according to a fourth exemplary embodiment.

In FIG. 12, the basic configuration of the color shift sensor 100 (one example of the image position detecting device) is similar to that of the third exemplary embodiment and is different from that of the third exemplary embodiment in that an optical imaging lens 122 is disposed with inclining at a predetermined angle θ with respect to an axis of an optical path so as to decrease a difference between (i) an optical path length between one of the light receiving portions 121 and the irradiated color shift detecting mark M (Ma to Md) and (ii) an optical path length between the other light receiving portion 121 and the irradiated color shift detecting mark M (Ma to Md). It is noted that, in FIG. 12, a circle having a dot therein represents that the intermediate transfer belt 40 travels the rear side of the paper of FIG. 12 to the front side thereof. In the exemplary embodiment, when viewed from above the color shift sensor 100, the light irradiating unit 110 (particularly, light emitting portion 111) and the photodetector 120 (particularly, light receiving portions 121) are arranged along a direction substantially perpendicular to the travel direction of the intermediate transfer belt 40.

In the fourth exemplary embodiment, it is possible to suppress the difference between the optical path lengths to the light receiving portions 121 of the photodetector 120 having the pair structure. Therefore, the light regularly reflected by the color shift detecting pattern M forms an image on the light receiving portions 121 with a small amount of out-of-focus. Thus, the detection sensitivities of the color shift sensor 100 can have higher accuracy.

For this reason, even if a process speed of an image forming apparatus is enhanced, for example, the color shift sensor 100 can also be used for such a high speed image forming apparatus because the color shift sensor 100 has highly accurate detection sensitivities.

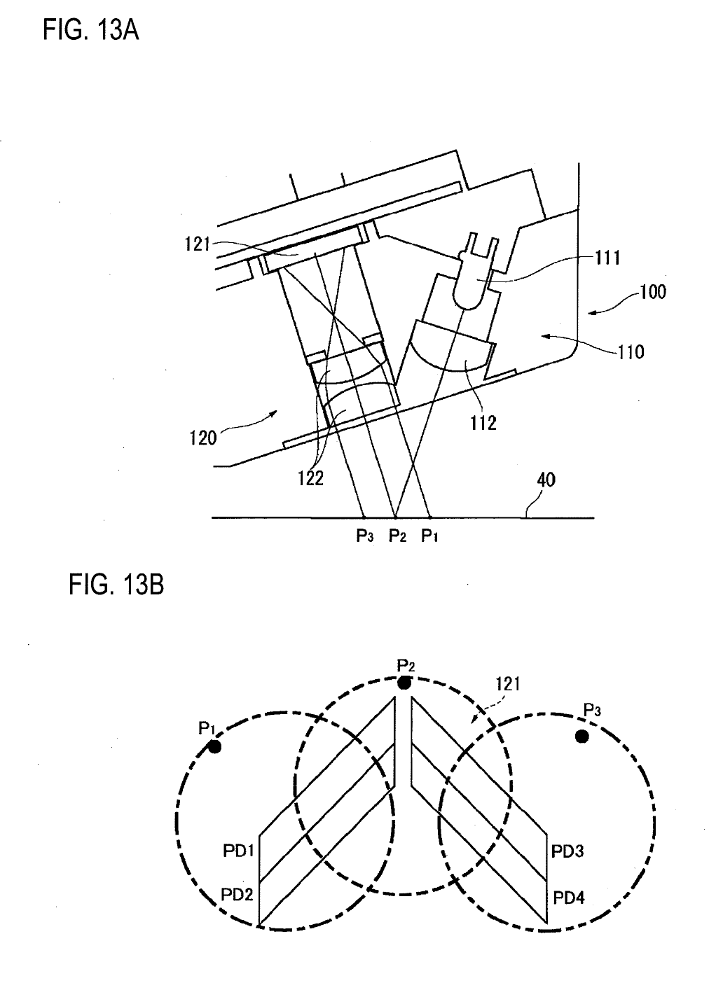

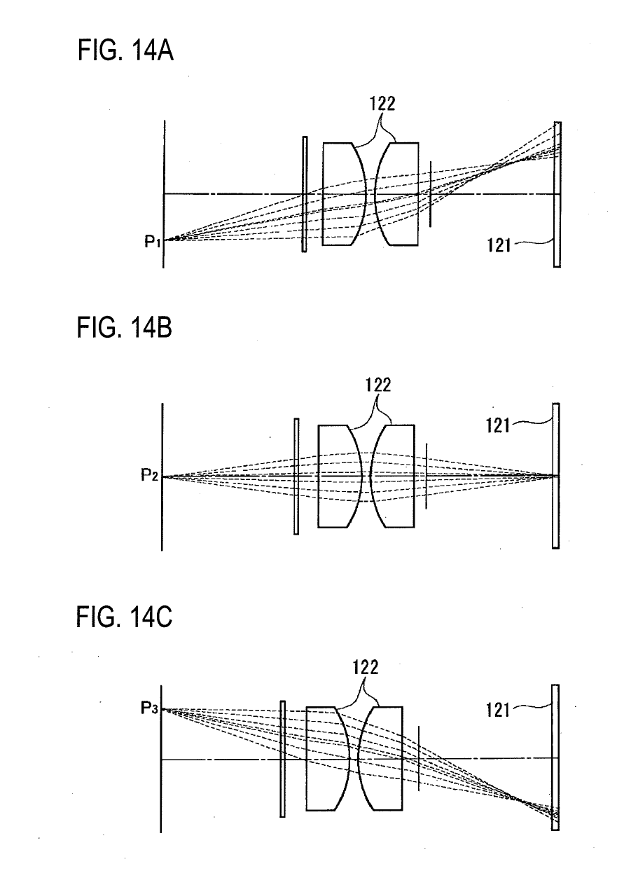

It is assumed that, in an example in which the optical imaging lens 122 is disposed without inclination, three points P₁ to P₃ are defined in a region on an intermediate transfer belt 40 which is irradiated with light by the light irradiating unit 110 as shown in FIGS. 13A and 13B. In this case, an optical path trajectory to the light receiving portions 121 of the photodetector 120 having the pair structure is considered below. With regard to the point P₂ (which corresponds to the vicinity of the central axis of the light receiving portions 121 having the pair structure), the light regularly reflected by the color shift detecting pattern M forms an image in focus on the light receiving portions 121 having the pair structure as shown in FIG. 14B.

However, with regard to the points P₁ and P₃ (which correspond to the vicinity of portions apart, in the width direction, from the central axis of the light receiving portions 121 having the pair structure), the light regularly reflected by the color shift detecting pattern M forms an image in a state of out-of-focus from the light receiving portions 121 having the pair structure, as shown in FIG. 14A or 14C.

Therefore, it can be understood that, in the exemplary embodiment, the detecting accuracy of the color shift sensor 100 is enhanced more greatly as compared with the case where a layout of the optical imaging lens 122 is not adjusted.

### Example 1

In Example 1, the color shift sensor 100 according to the fourth exemplary embodiment is used. A relationship between a focal length and color registration (color shift) in a lateral direction (−Lat) and a process direction (−Pro) for the Y, M and K colors is examined. For example, the lateral direction is a widthwise direction of the intermediate transfer belt 40, and the process direction is a moving direction of the intermediate transfer belt 40. Alternatively, the lateral direction may be a direction perpendicular to the intermediate transfer belt 40, and the process direction may be a direction parallel to the intermediate transfer belt 40.

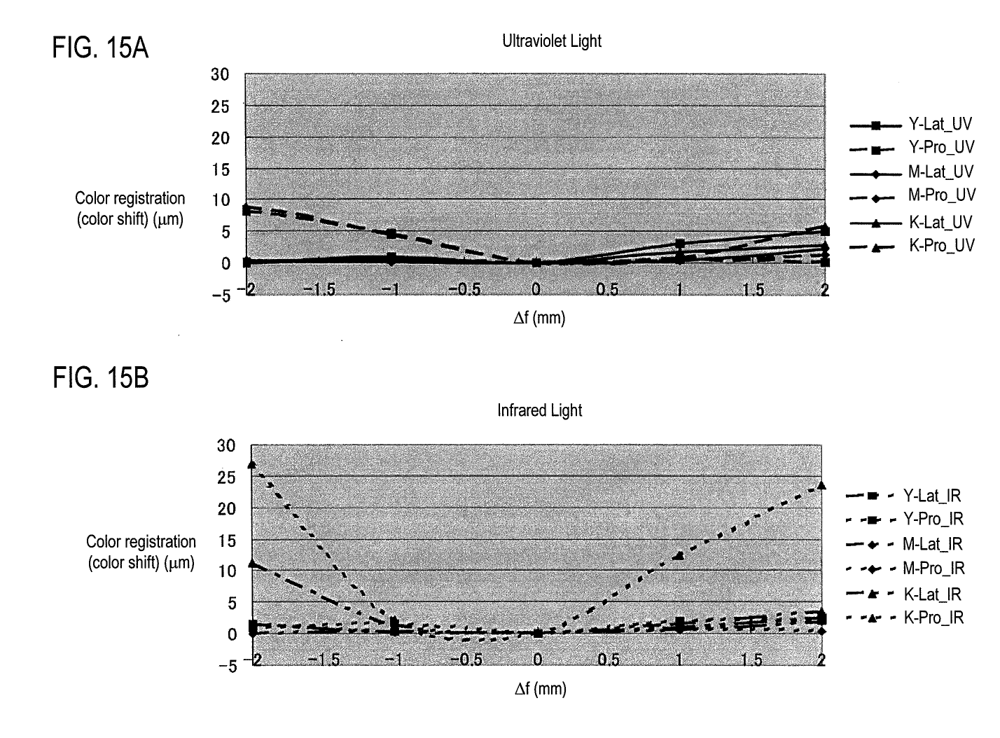

The “focal length” means a focal length of an optical system between the color shift detecting pattern M and the light receiving portions 121 of the photodetector 120. In FIGS. 15A and 15B, the abscissa represents a difference Δf between a focal length under test and the optimum focal length. That is, when Δf=0, the focal length under test is identical with the optimum focal length. In Example 1, the optimum focal length is 8.0 mm. It should be noted that although the optimum focal length of Example 1 is 8.0 mm, the invention is not limited thereto.

The examination results are shown in FIG. 15A.

As shown in FIG. 15A, it can be understood that the color registration (the color shift) does not varied greatly even if the focal length slightly varies.

In Comparative Example 1 (in which a light irradiating unit emits only light having a wavelength in an infrared region), a relationship between the focal length and the color registration is examined on the same condition as that in Example 1. Consequently, examination results shown in FIG. 15B are obtained.

In Comparative Example 1, it can be understood that the color registration for the K color is increased with an increase in variation of the focal length as compared with the other color components (Y and M colors) and that higher accuracy in an assembling work of the color shift sensor 100 would be correspondingly indispensable. Consequently, it is concerned that the assembling work of the color shift sensor 100 might be burdensome.

### Example 2

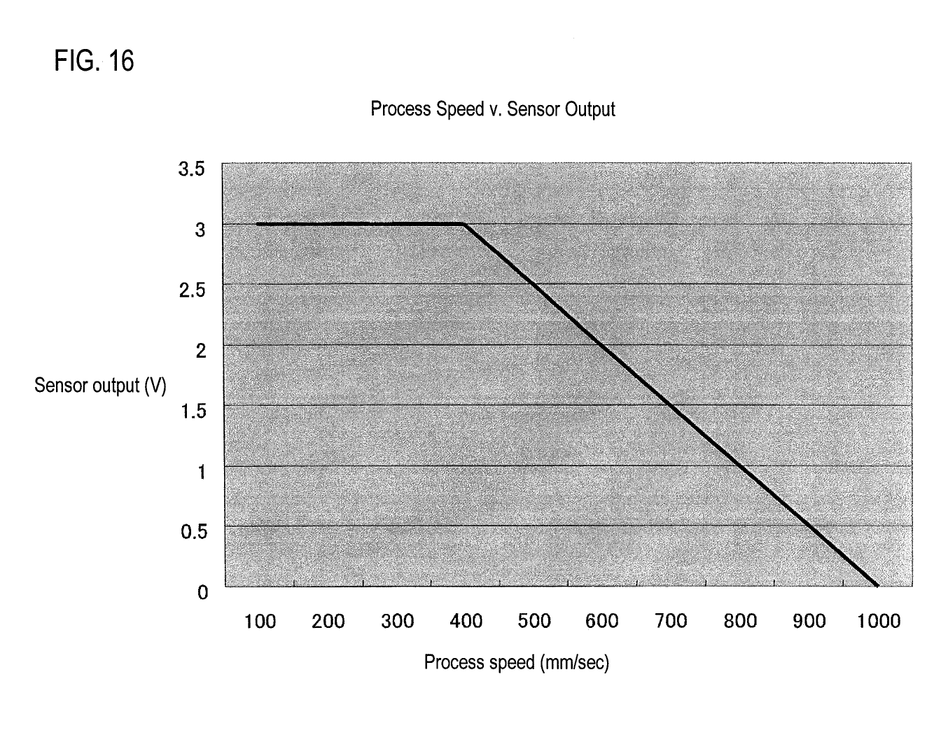

In Example 2, the color shift sensor according to the second exemplary embodiment is used. A relationship between a process speed of an image forming apparatus and a sensor output of the color shift sensor is examined. Then, an examination result shown in FIG. 16 is obtained.

As shown in FIG. 16, it can be understood that the sensor output is reduced with an increase in process speed of the image forming apparatus. In the first to fourth exemplary embodiments described above, however, the color shift sensor has a high accuracy in sensor sensitivity. Therefore, even if the process speed is set to be high and the sensor output is reduced to some extent, detection accuracy of the color shift sensor is maintained to be excellent.

In Example 2, the detection accuracy of the color shift sensor is excellent on the condition that the process speed is 600 mm/sec or less.

### Example 3

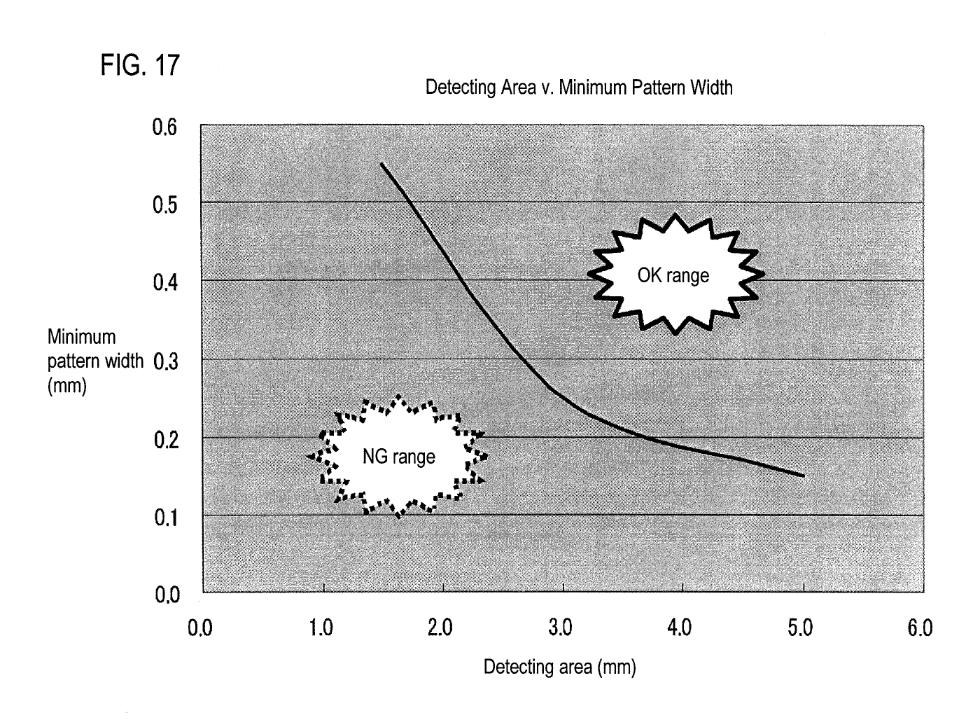

In Example 3, the color shift sensor 100 according to the fourth exemplary embodiment is used. A relationship between (i) a detecting area (a circular region having a diameter changed) of the light receiving portions 121 of the photodetector 120 having the pair structure and (ii) a minimum pattern width of the color shift detecting pattern M (a minimum value of pattern widths in the moving direction of the intermediate transfer belt (subscanning direction) and the direction crossing the moving direction (main scanning direction)). Then, an examination result shown in FIG. 17 is obtained.

An NG region means that pattern detection accuracy of the color shift sensor is reduced, and it is impossible to detect patterns. An OK region means that high pattern detection accuracy of the color shift sensor is maintained.

In Example 3, it can be understood that detection accuracy of the color shift sensor can be maintained to be excellent even if the minimum pattern width is small to some extent in the case where the detecting area is set to be large.

What is claimed is:

1. An image position detecting device comprising:
a light irradiating unit that is disposed so as to face a movable body which is being moved in a certain direction, the light irradiating unit that irradiates any of marks formed on the movable body with light having a wavelength in an ultraviolet range at a time, wherein the marks are formed of color components, respectively; and
a photodetector that is provided separately from the light irradiating unit to face the movable body, the photodetector that detects the light having the wavelength in the ultraviolet range from light regularly reflected by the irradiated mark.

2. The image position detecting device according to claim 1, wherein the light irradiating unit irradiates any of the mark only with the light having the wavelength in the ultraviolet range at a time.

3. The image position detecting device according to claim 1, wherein
the light with which the light irradiating unit irradiates any of the marks at a time has the wavelength in the ultraviolet range and a wavelength in a range other than the ultraviolet range, and
the photodetector includes a light eliminating member that eliminates the light having the wavelength in the range other than the ultraviolet range.

4. The image position detecting device according to claim 1, wherein
the light irradiating unit includes
an emission portion that emits the light having the wavelength in the ultraviolet range, and
an optical guiding member that guides the light from the emission portion toward any of the marks in a state where the light emitted from the emission portion is a parallel light beam.

5. The image position detecting device according to claim 2, wherein
the light irradiating unit includes
an emission portion that emits the light having the wavelength in the ultraviolet range, and
an optical guiding member that guides the light from the emission portion toward any of the marks in a state where the light emitted from the emission portion is a parallel light beam.

6. The image position detecting device according to claim 3, wherein
the light irradiating unit includes
an emission portion that emits the light having the wavelength in the ultraviolet range, and
an optical guiding member that guides the light from the emission portion toward any of the marks in a state where the light emitted from the emission portion is a parallel light beam.

7. The image position detecting device according to claim 1, wherein
the photodetector includes a pair of light receiving portions, and
the light receiving portions are symmetrically arranged with respect to a reference centerline.

8. The image position detecting device according to claim 2, wherein
the photodetector includes a pair of light receiving portions, and
the light receiving portions are symmetrically arranged with respect to a reference centerline.

9. The image position detecting device according to claim 3, wherein
the photodetector includes a pair of light receiving portions, and
the light receiving portions are symmetrically arranged with respect to a reference centerline.

10. The image position detecting device according to claim 4, wherein
the photodetector includes a pair of light receiving portions, and
the light receiving portions are symmetrically arranged with respect to a reference centerline.

11. The image position detecting device according to claim 5, wherein
the photodetector includes a pair of light receiving portions, and
the light receiving portions are symmetrically arranged with respect to a reference centerline.

12. The image position detecting device according to claim 6, wherein
the photodetector includes a pair of light receiving portions, and
the light receiving portions are symmetrically arranged with respect to a reference centerline.

13. The image position detecting device according to claim 7, wherein
the photodetector further includes an optical imaging member in an optical path of the light regularly reflected by the irradiated mark,
the optical imaging member focuses the light regularly reflected by the irradiated mark into an image on the pair of light receiving portions,
the optical imaging member is inclined with respect to an axis of the optical path so as to decrease a difference between (i) an optical path length between one of the light receiving portions and the irradiated mark and (ii) an optical path length between the other light receiving portion and the irradiated mark.

14. The image position detecting device according to claim 7, wherein
the photodetector further includes a substrate on which the light receiving portions are mounted, and
the substrate is inclined with respect to an axis of the optical path so as to decrease a difference between (i) an optical path length between one of the light receiving portions and the irradiated mark and (ii) an optical path length between the other light receiving portion and the irradiated mark.

15. The image position detecting device according to claim 7, wherein the light irradiating unit and the photodetector are disposed so that the light irradiating unit is located in a direction extending along a centerline for the pair of light receiving portions of the photodetector.

16. An image forming apparatus comprising:
a movable body configured to be moved in a certain direction;
an image forming section that forms marks having color components, respectively; and
an image position detecting device that detects the marks, wherein
the image position detecting device includes
a light irradiating unit that is disposed so as to face the movable body, the light irradiating unit that irradiates any of the marks with light having a wavelength in an ultraviolet range at a time; and
a photodetector that is provided separately from the light irradiating unit to face the movable body, the photodetector that detects the light having the wavelength in the ultraviolet range from light regularly reflected by the irradiated mark.
